(19) United States
(12) Patent Application Publication
(10) Pub. No.: US 2011/0063420 A1
(43) Pub. Date: Mar. 17, 2011

(54) IMAGE PROCESSING APPARATUS

(76) Inventor: Tomonori MASUDA, Saitama-shi (JP)

(21) Appl. No.: 12/879,034

(22) Filed: Sep. 10, 2010

(30) Foreign Application Priority Data
Sep. 11, 2009 (JP) 2009-210737

(51) Int. Cl. H04N 13/02

(52) U.S. Cl. 348/50; 348/E13.074

(57) ABSTRACT

An image processing apparatus includes: an image acquisition device configured to acquire a first image and a second image for generating a stereo image; a parallax calculation device configured to calculate a parallax indicating a shift amount and a shift direction of a corresponding pixel of the second image with respect to each pixel of the first image; a parallax outline extraction device configured to extract a parallax outline, from a parallax map; a window setting device configured to set and sequentially move a pair of search windows along the parallax outline; a window determination device configured to determine a search window including an occlusion region on the basis of the first image within the pair of search windows; and a parallax correction device configured to correct a parallax of the occlusion region within the determined search window, on the basis of a parallax of another (not determined) search window.

### BACKGROUND OF THE INVENTION

1. Field of the Invention

The presently disclosed subject matter relates to an image processing apparatus, and more particularly, to an image processing apparatus adapted to obtain a parallax from a plurality of images which can be used for generating a stereo image.

2. Description of the Related Art

A technology of generating an image at an arbitrary intermediate point of view from two images which are taken from different points of view to generate a stereo image is important for displaying an appropriate stereoscopic image on a stereoscopic photograph print having a surface on which a lenticular lens sheet is attached or on other various stereoscopic image display devices.

In order to generate the image at the intermediate point of view, with reference to one image of the two images having different points of view, it is necessary to calculate, for each pixel of the reference image, a pixel shift (parallax) between a pixel of the reference image and a corresponding pixel of another image, to thereby create a map of the parallaxes (parallax map) of one screen.

When creating the parallax map, there is a blind region (occlusion region) which exists in one image but does not exist in another image between the two images having different points of view, and there arises a problem that the parallax cannot be calculated in the occlusion region.

Conventionally, in Japanese Patent Application Laid-Open No. 09-27969 for solving this problem, in the occlusion region, search windows are set on the right side and the left side of an outline of an object so as to sandwich the outline, the dispersion of the parallax within each of the right and left search windows is obtained, it is assumed that the occlusion region exists in a search window having a larger dispersion, and the parallax of the occlusion region is corrected by the parallax indicating a far side within the parallax of the search window having a larger dispersion.

### SUMMARY OF THE INVENTION

Japanese Patent Application Laid-Open No. 09-27969 utilizes that a pixel of one image is different from the pixel corresponded with a pixel of another image corresponded with the pixel of the one image, in the occlusion region, to thereby determine the occlusion region and virtually substitute the parallax, and then assumes that the occlusion region exists in a search window having a larger dispersion, on the basis of the dispersion of the parallax within each of the search windows which are set on the right side and the left side of the outline of the object so as to sandwich the outline. However, the correspondence at the same pixel is not necessarily different between the right and left images in the occlusion region, and the parallax of the occlusion region (the parallax which is virtually substituted because the parallax cannot be detected) is also used for calculating the dispersion. Therefore, there arises a problem that a dispersion value to be calculated is not reliable.

The presently disclosed subject matter has been made in view of the above-mentioned circumstances, and therefore has an object to provide an image processing apparatus being capable of correcting with accuracy an error of the parallax obtained from a plurality of images which can be used for generating a stereo image.

In order to achieve the above-mentioned object, a first aspect of the presently disclosed subject matter provides an image processing apparatus including: an image acquisition device configured to acquire a first image and a second image which can be used for generating a stereo image; a parallax calculation device configured to calculate a parallax indicating a shift amount and a shift direction of a corresponding pixel of the second image with respect to each pixel of the first image; a parallax outline extraction device configured to extract a parallax outline in which the parallax suddenly changes, from a parallax map indicating the parallax calculated by the parallax calculation device; a window setting device configured to set a pair of search windows and sequentially move the pair of search windows along the parallax outline extracted by the parallax outline extraction device, the pair of search windows being in contact with the parallax outline and opposed to each other so as to sandwich the parallax outline; a window determination device configured to determine a search window including an occlusion region on the basis of the first image within the pair of search windows set by the window setting device; and a parallax correction device configured to correct a parallax of the occlusion region within the search window determined by the window determination device, on the basis of a parallax of another search window which is not determined by the window determination device.

That is, the parallax map indicating the shift (parallax) between corresponding pixels is created on the basis of the first image and the second image which are taken as a stereo image, and the parallax outline in which the parallax suddenly changes is obtained from the created parallax map. There is a possibility that the occlusion region exists adjacently to the parallax outline. An accurate parallax cannot be calculated in the occlusion region, so that an incorrect parallax is set. Anyway, it is possible to at least detect the parallax outline. Then, the pair of search windows which is opposed to each other so as to sandwich the parallax outline is set, and the search window including the occlusion region is determined on the basis of the first image within the pair of search windows. In this way, it is determined on the basis of the feature of the first image within the pair of search windows which of the pair of search windows includes the occlusion region, and hence the occlusion region can be properly determined. Then, the parallax of the occlusion region within the search window in which the occlusion region exists is corrected on the basis of the parallax of another search window. Accordingly, it makes it possible to correct with accuracy an error of the parallax of the occlusion region.

A second aspect of the presently disclosed subject matter provides an image processing apparatus according to the first aspect, wherein the parallax calculation device detects, by block matching between the second image and an image having a predetermined block size defined with reference to a target pixel of the first image, a corresponding pixel of the second image corresponding to the target pixel of the first image, to thereby calculate the parallax between the target pixel of the first image and the corresponding pixel of the second image. It should be noted that the matching degree between blocks cannot be evaluated by the block matching in the occlusion region, so that the calculated parallax contains an error. However, a proper parallax can be calculated for a part (large part) in which corresponding pixels between the first and second images exist.

A third aspect of the presently disclosed subject matter provides an image processing apparatus according to the second aspect, wherein the search window has a size which is the same as the predetermined block size defined when the parallax calculation device calculates the parallax.

A fourth aspect of the presently disclosed subject matter provides an image processing apparatus according to any one of the first to third aspects, wherein: the window determination device includes an image outline extraction device configured to cut out images within the pair of search windows from the first image and extract an image outline from each of the cut-out images; and the window determination device determines a search window corresponding to an image having a larger image outline extracted by the image outline extraction device, as the search window including the occlusion region.

There is a possibility that the occlusion region exists adjacently to the parallax outline in which the parallax suddenly changes. In the case where the occlusion region exists, there exists an outline of an image of luminance (color) as a boundary between a short-distance image and a long-distance image in the vicinity of the occlusion region. In view of this, the image outline is searched for by the pair of search windows, and the search window corresponding to the image having a larger image outline is determined as the search window including the occlusion region.

A fifth aspect of the presently disclosed subject matter provides an image processing apparatus according to the fourth aspect, wherein the parallax correction device corrects the parallax between the image outline within the search window determined by the window determination device and the parallax outline, on the basis of the parallax of the another search window which is not determined by the window determination device. That is, a part between the image outline and the parallax outline corresponds to the occlusion region, and hence the parallax of the occlusion region is corrected on the basis of the parallax of the another search window.

A sixth aspect of the presently disclosed subject matter provides an image processing apparatus according to any one of the first to third aspects, wherein: the window determination device includes a matching degree calculation device configured to cut out images within the pair of search windows from the first image and calculate a matching degree between divided images obtained by dividing each of the cut-out images into a right part and a left part; and the window determination device determines a search window corresponding to an image having a lower matching degree calculated by the matching degree calculation device, as the search window including the occlusion region.

In the image within the search window including the occlusion region, there is not a correlation between an image corresponding to the occlusion region and an image other than the image corresponding to the occlusion region, and hence the matching degree between the divided images obtained by dividing into the right part and the left part becomes lower. In view of this, the search window corresponding to the image having a lower matching degree is determined as the search window including the occlusion region. It should be noted that, in the case where both the matching degrees between the right and left divided images of the respective images within the pair of search windows are high, it can be concluded that the occlusion region does not exist within these search windows.

A seventh aspect of the presently disclosed subject matter provides an image processing apparatus according to the sixth aspect, wherein the matching degree calculation device calculates the matching degree by one of pattern matching and histogram matching of the divided images obtained by dividing into two.

An eighth aspect of the presently disclosed subject matter provides an image processing apparatus according to any one of the first to third aspects, wherein: the window determination device includes a contrast calculation device configured to cut out images within the pair of search windows from the first image and calculate a contrast of each of the cut-out images; and the window determination device determines a search window corresponding to an image having a larger contrast calculated by the contrast calculation device, as the search window including the occlusion region.

A ninth aspect of the presently disclosed subject matter provides an image processing apparatus according to the eighth aspect, wherein the contrast calculation device calculates one of a dispersion and a standard deviation of a pixel value of each of the cut-out images as an index indicating a magnitude of the contrast.

In the image within the search window including the occlusion region, the image outline and the like exist, and moreover, there is not a correlation between an image corresponding to the occlusion region and an image other than the image corresponding to the occlusion region. Hence, the dispersion or the standard deviation becomes larger.

In view of this, the search window corresponding to the image having a larger dispersion or standard deviation is determined as the search window including the occlusion region.

A tenth aspect of the presently disclosed subject matter provides an image processing apparatus according to any one of the fifth to ninth aspects, wherein the parallax correction device corrects the parallax which is within the search window determined by the window determination device and corresponds to a parallax which is located on a side of the parallax outline, of parallaxes divided into a right part and a left part, on the basis of the parallax of the another search window which is not determined by the window determination device.

An eleventh aspect of the presently disclosed subject matter provides an image processing apparatus according to any one of the fifth to ninth aspects, wherein: the parallax correction device includes a device configured to extract the image outline from the image within the search window determined by the window determination device; and the parallax correction device corrects the parallax between the extracted image outline and the parallax outline, on the basis of the parallax of the another search window which is not determined by the window determination device.

According to the presently disclosed subject matter, the parallax outline in which the parallax suddenly changes is obtained on the basis of the parallax map created from a plurality of images which can be used for generating a stereo image, the pair of search windows which is opposed to each other so as to sandwich the parallax outline is set, and the search window including the occlusion region is determined on the basis of the images within the pair of search windows. Accordingly, the occlusion region can be properly determined. In addition, the parallax of the occlusion region within the search window in which the occlusion region exists is corrected on the basis of the parallax of the another search window. Accordingly, the error of the parallax of the occlusion region can be corrected with accuracy.

### BRIEF DESCRIPTION OF THE DRAWINGS

FIG. 1A and FIG. 1B are views illustrating a left image and a right image in which a scene where a main subject (person) exists in a near view is taken in stereo from two different points of view, respectively;

FIG. 2 is a view illustrating a relation among a parallax outline, an image outline and an occlusion region;

FIG. 3 is a view illustrating a state where a pair of search windows is set onto the left image on which the parallax outline is superimposed and displayed;

FIG. 4 is a view illustrating a correction work image in which an error of a parallax of the occlusion region is corrected while moving the pair of search windows along the parallax outline on the left image;

FIG. 5 is a block diagram illustrating an image processing apparatus according to a first embodiment of the presently disclosed subject matter;

FIG. 6 is a flowchart illustrating a processing procedure of the image processing apparatus according to the first embodiment;

FIG. 7 is a block diagram illustrating an image processing apparatus according to a second embodiment of the presently disclosed subject matter;

FIG. 8 is a flowchart illustrating a processing procedure of the image processing apparatus according to the second embodiment;

FIGS. 9A and 9B are views illustrating a state where the pair of search windows which is set so as to sandwich the parallax outline is divided into two;

FIG. 10 is a block diagram illustrating an image processing apparatus according to a third embodiment of the presently disclosed subject matter;

FIG. 11 is a flowchart illustrating a processing procedure of the image processing apparatus according to the third embodiment; and

FIG. 12 is a flowchart illustrating a modified example of the third embodiment.

### DETAILED DESCRIPTION OF THE PREFERRED EMBODIMENTS

Hereinafter, an image processing apparatus according to each of embodiments of the presently disclosed subject matter is described with reference to the accompanying drawings.

First, an outline of the presently disclosed subject matter is described.

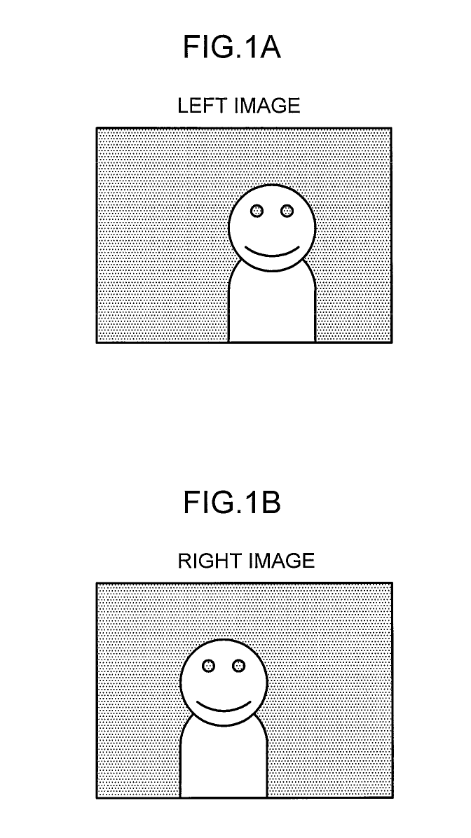

FIG. 1A and FIG. 1B are a left image and a right image in which a scene where a main subject (person) exists in a near view is taken in stereo from two different points of view, respectively.

With reference to one image (for example, the left image) of the left image and the right image, pixels of another image (right image) respectively corresponding to pixels of the left image are obtained.

For example, a block matching method can be adopted as a method of obtaining such corresponding pixels.

The matching degree between a block which is cut out from the left image with reference to an arbitrary pixel thereof and has a predetermined block size and a block of the right image is evaluated. Then, a reference pixel of the block of the right image when the matching degree between the blocks is the highest is assumed as a pixel of the right image corresponding to the arbitrary pixel of the left image.

As a function for evaluating the matching degree between the blocks in the block matching method, for example, there is a method of using a sum of squared differences (SSD) in luminance of pixels within each block (SSD block matching method).

In the SSD block matching method, calculation using the following expression is performed for respective pixels f(i, j) and g(i, j) within the blocks of both the images.

$$SSD = {\sum }_{i} {\sum }_{j} {\{ f ( i , j ) - g ( i , j ) \}}^{2} \qquad [ Expression 1 ]$$

The calculation using Expression 1 given above is performed while moving the position of the block within a predetermined search region on the right image, and a pixel located at a position within the search region when the SSD is the smallest is assumed as a search target pixel.

Then, the parallax indicating a shift amount and a shift direction between the position of the pixel on the left image and the position of the corresponding pixel searched for on the right image is obtained (in the case where the right and left images are taken in a horizontal state, the shift direction can be expressed by positive and negative values).

For all the pixels of the left image, the parallaxes thereof with respect to the corresponding pixels are obtained as described above, to thereby create a parallax map indicating the parallaxes of one screen.

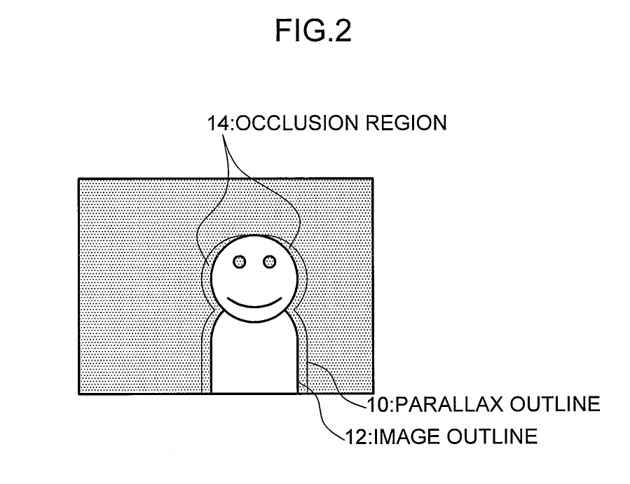

The presently disclosed subject matter extracts a parallax outline (contour) 10 in which the parallax suddenly changes, from the parallax map created as illustrated in FIG. 2. There is a blind region (occlusion region) which exists in one image of the right and left images but does not exist in another image thereof between the parallax outline 10 and an outline 12 (hereinafter, referred to as “image outline”) of the luminance (color) on the reference left image. Pixels in the occlusion region do not have corresponding pixels, and thus do not have search target pixels at which the SSD is the smallest, so that the parallax cannot be calculated accurately. For example, the pixel located at a position which is calculated within the search region and at which the SSD is the smallest is not a search target pixel, and hence the parallax calculated in the occlusion region is not accurate.

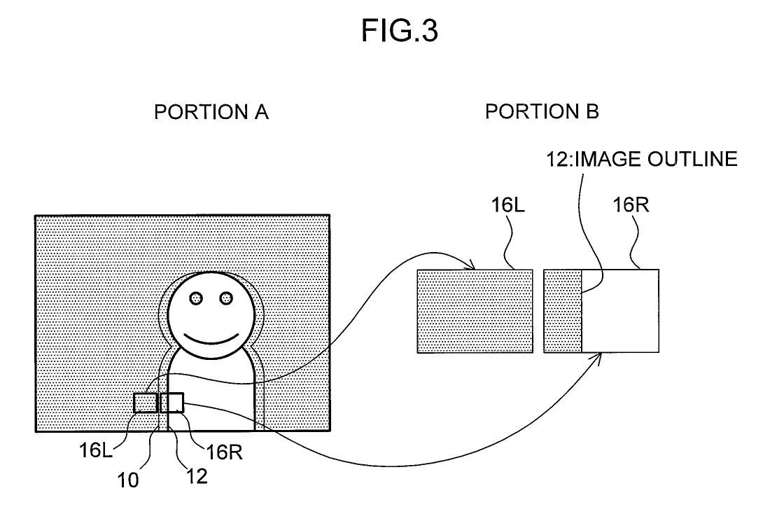

FIG. 3 is a view in which the parallax outline 10 is superimposed and displayed on the left image. As illustrated in FIG. 3 (PORTION A), the presently disclosed subject matter sets a pair of search windows 16L and 16R which is in contact with the parallax outline 10 so as to sandwich the parallax outline 10. The size of the search windows 16L and 16R is set to, for example, the same size as the size of the block when a corresponding pixel is searched for in the block matching method described above. It should be noted that parts of the reference image (in this example, the left image) within the pair of search windows 16L and 16R are cut out, and it is determined on the basis of feature amounts of the cut-out images which of the search windows 16L and 16R is a search window including the occlusion region (PORTION B).

Then, the parallax of the determined search window within the occlusion region is corrected (replaced) on the basis of the parallax of another search window which is not determined, whereby an error of the parallax of the occlusion region in the parallax map is corrected.

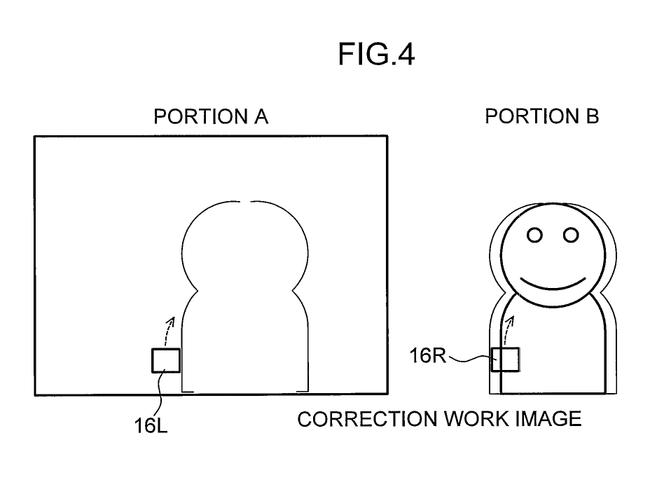

FIG. 4 illustrates a correction work image in which the error of the parallax of the occlusion region is corrected while moving the pair of search windows 16L (PORTION A) and 16R (PORTION B) along the parallax outline 10.

### First Embodiment

Next, an image processing apparatus according to a first embodiment of the presently disclosed subject matter is described.

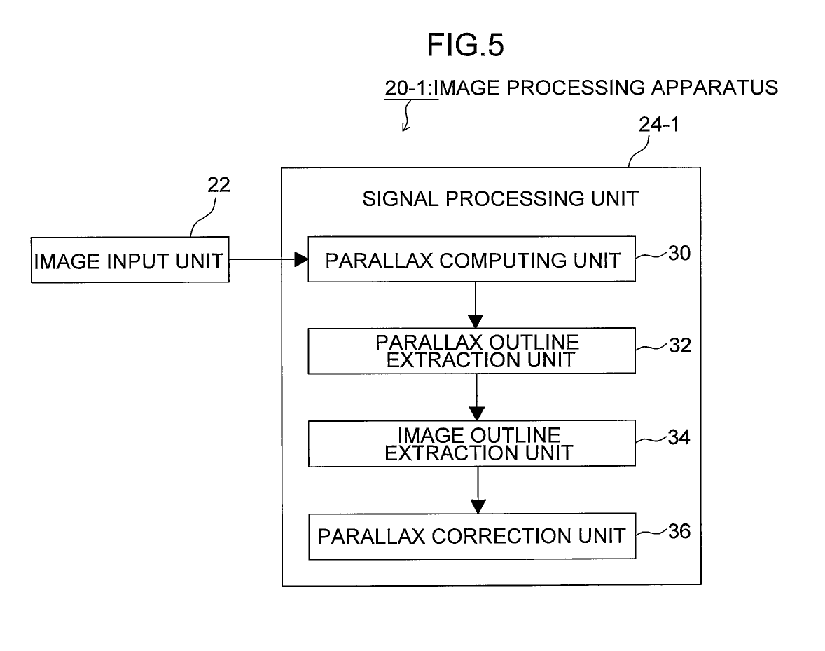

FIG. 5 is a block diagram illustrating the image processing apparatus 20-1 according to the first embodiment of the presently disclosed subject matter.

The image processing apparatus 20-1 is configured by, for example, a personal computer or a workstation, and includes an image input unit 22 and a signal processing unit 24-1.

The image input unit 22 captures a left image and a right image which are taken as a stereo image, and corresponds to, for example, an image reading device that reads a multiple picture file (MP file) from a recording medium which records therein the MP file in which multi-view images for a stereoscopic image are connected to each other, or a device that acquires the MP file via a network.

The signal processing unit 24-1 includes a parallax computing unit 30, a parallax outline extraction unit 32, an image outline extraction unit 34, and a parallax correction unit 36.

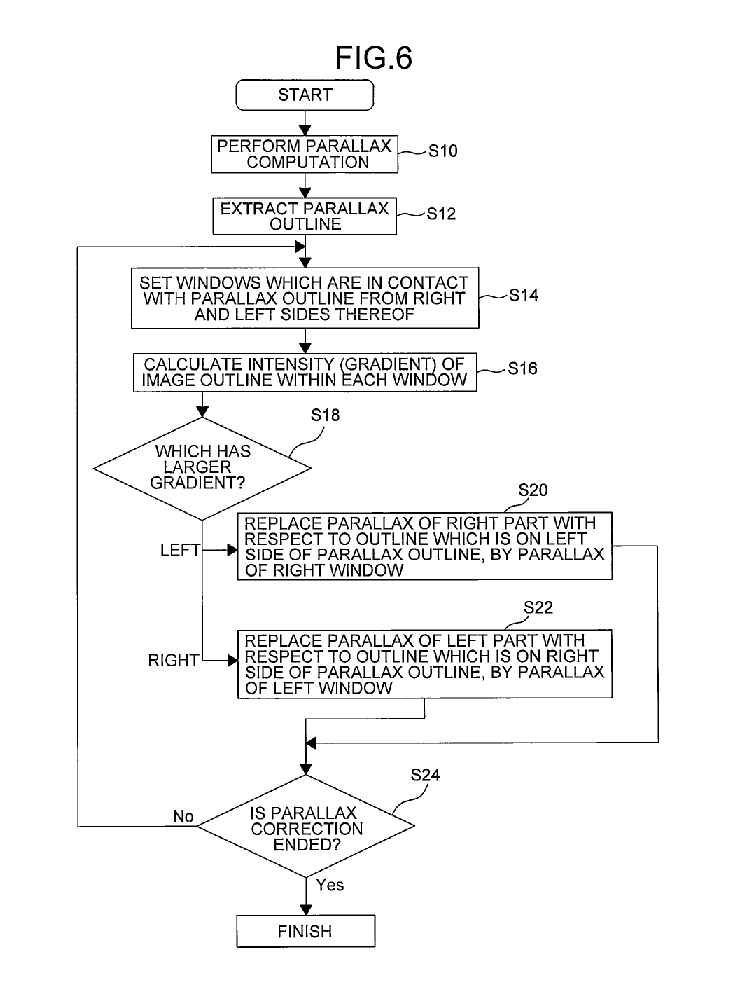

Hereinafter, the processing operation of the respective units of the signal processing unit 24-1 is described with reference to a flowchart illustrated in FIG. 6.

The parallax computing unit 30 performs parallax computation on the basis of the left image and the right image which are inputted from the image input unit 22 and have different points of view (Step S10 in FIG. 6). In the present embodiment, with reference to the left image, pixels of the right image respectively corresponding to pixels of the left image are obtained. The block matching method described above is used for searching for the corresponding pixels. Then, the parallax between the position of the pixel on the left image and the position of the corresponding pixel searched for on the right image is calculated, to thereby create a parallax map indicating the parallaxes of one screen.

The parallax outline extraction unit 32 extracts a parallax outline in which the parallax suddenly changes, from the created parallax map (Step S12 in FIG. 6). It should be noted that a threshold value for extracting the parallax outline is set in advance, and a portion at which the difference between adjacent parallaxes within the parallax map exceeds the set threshold value is extracted, whereby the parallax outline can be extracted. In addition, it is preferable to decide the threshold value in accordance with an image size of an image output device that uses the parallax map created according to the presently disclosed subject matter, generates an image at an intermediate point of view of a stereo image, and outputs the stereo image at a desired point of view (a print size of a stereoscopic photograph print and a screen size of a stereoscopic image display device).

With respect to the parallax outline 10 extracted by the parallax outline extraction unit 32 as illustrated in FIG. 3, the image outline extraction unit 34 sets the pair of search windows 16L and 16R which is in contact with the parallax outline 10 so as to sandwich the parallax outline 10 (Step S14 in FIG. 6). Then, parts of the left image within the pair of search windows 16L and 16R are cut out, and an intensity (gradient) of the image outline of each of the cut-out images is calculated (Step S16 in FIG. 6).

The parallax correction unit 36 determines the search window in which the image whose calculated intensity (gradient) of the image outline is larger is cut out and displayed therein, as a search window including the occlusion region (Step S18 in FIG. 6), and corrects the parallax of the occlusion region in accordance with a result of the determination.

That is, if the intensity (gradient) of the image outline of the image which is cut out by the left search window 16L is larger, a part of the region within the left search window 16L, which is on the left side of the parallax outline and on the right side of the image outline, is determined as the occlusion region, and the parallax of the determined occlusion region is replaced by the parallax of the right search window 16R (Step S20 in FIG. 6). On the other hand, if the intensity (gradient) of the image outline of the image which is cut out by the right search window 16R is larger, a part of the region within the right search window 16R, which is on the right side of the parallax outline and on the left side of the image outline, is determined as the occlusion region, and the parallax of the determined occlusion region is replaced by the parallax of the left search window 16L (Step S22 in FIG. 6).

As illustrated in FIG. 4, the parallax outline extraction unit 32, the image outline extraction unit 34, and the parallax correction unit 36 correct the parallax of the occlusion region while moving the pair of search windows 16L and 16R along the parallax outline, and set the search windows 16L and 16R to all the parallax outlines within the parallax map to perform the same processing thereon (Steps S14 to S24).

### Second Embodiment

Next, an image processing apparatus according to a second embodiment of the presently disclosed subject matter is described.

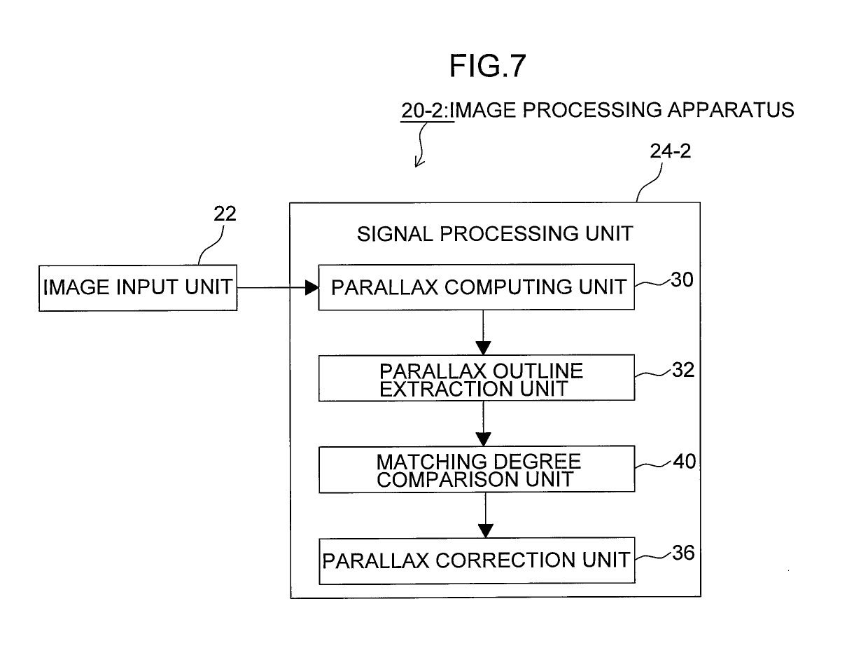

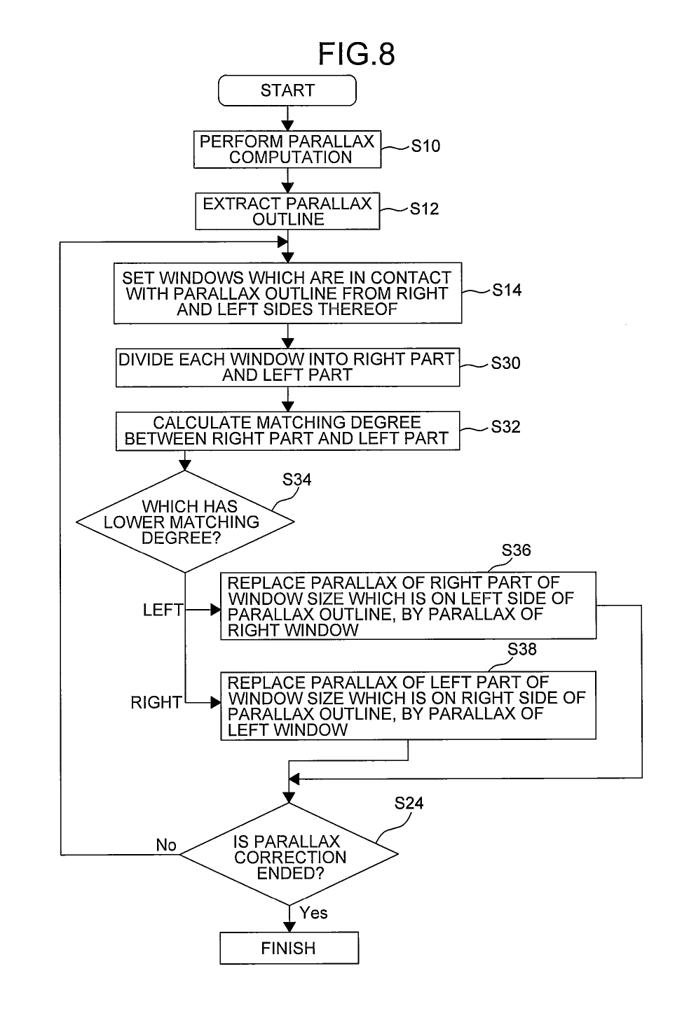

FIG. 7 is a block diagram illustrating the image processing apparatus 20-2 according to the second embodiment of the presently disclosed subject matter. FIG. 8 is a flowchart illustrating a processing procedure thereof. It should be noted that, in FIG. 7 and FIG. 8, components common to those of the first embodiment illustrated in FIG. 5 and FIG. 6 are denoted by the same reference numerals and characters, and detailed description thereof is omitted.

In FIG. 7, the second embodiment is different in that the image processing apparatus 20-2 of the second embodiment includes a matching degree comparison unit 40 instead of the image outline extraction unit 34 included in the image processing apparatus 20-1 of the first embodiment illustrated in FIG. 5.

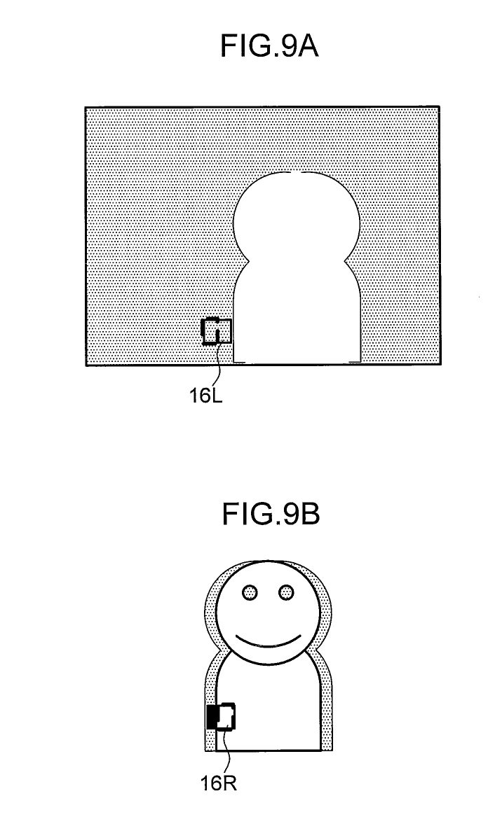

The matching degree comparison unit 40 included in the signal processing unit 24-2 obtains divided images by dividing respective images which are cut out by the pair of search windows 16L and 16R which is set so as to sandwich the parallax outline 10, into two, that is, a right part and a left part as illustrated in FIGS. 9A and 9B (Step S30 in FIG. 8), and calculates the matching degree between the right and left divided images within each of the search windows 16L and 16R (Step S32 in FIG. 8). The matching degree therebetween can be calculated by one of pattern matching and histogram matching of the right and left divided images.

Then, the parallax correction unit 36 determines the search window having a lower matching degree of the matching degrees which are calculated for each of the search windows 16L and 16R, as a search window including the occlusion region (Step S34 in FIG. 8), and corrects the parallax of the occlusion region in accordance with a result of the determination.

That is, if the matching degree between the divided images obtained by dividing the image which is cut out by the left search window 16L is lower, a right half of the region within the left search window 16L is determined as the occlusion region, and the parallax of the determined occlusion region is replaced by the parallax of the right search window 16R (Step S36 in FIG. 8). On the other hand, if the matching degree between the divided images obtained by dividing the image which is cut out by the right search window 16R is lower, a left half of the region within the right search window 16R is determined as the occlusion region, and the parallax of the determined occlusion region is replaced by the parallax of the left search window 16L (Step S38 in FIG. 8). It should be noted that, in the present embodiment, a half of the region within the search window is determined as the occlusion region, and the parallax thereof is corrected. Alternatively, as described in Steps S20 and S22 in the flowchart of FIG. 6, the occlusion region between the parallax outline and the image outline is obtained, so that the parallax of the occlusion region thus obtained may be corrected.

### Third Embodiment

Next, an image processing apparatus according to a third embodiment of the presently disclosed subject matter is described.

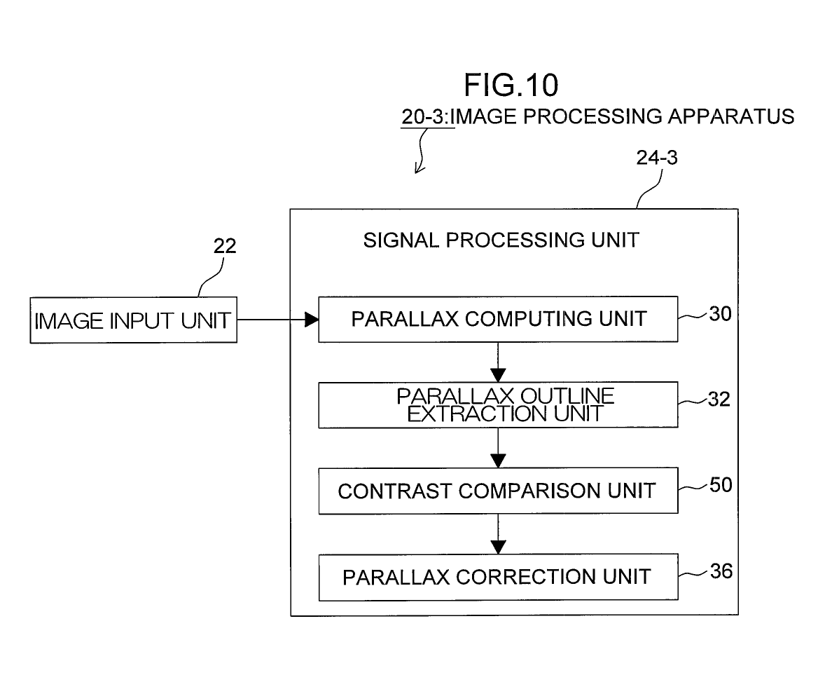

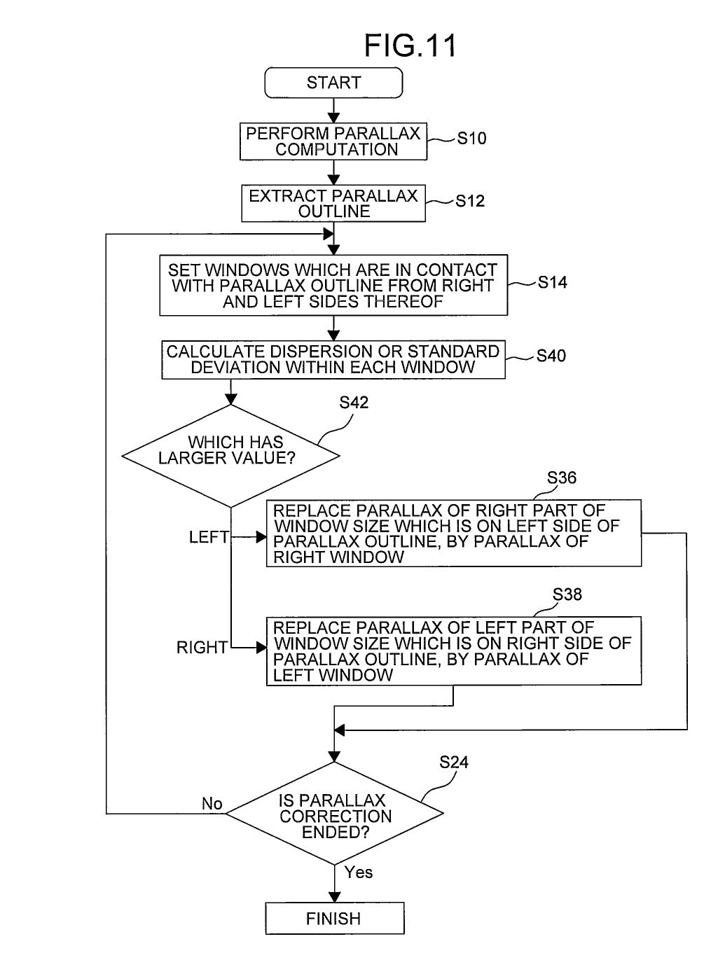

FIG. 10 is a block diagram illustrating the image processing apparatus 20-3 according to the third embodiment of the presently disclosed subject matter. FIG. 11 is a flowchart illustrating a processing procedure thereof. It should be noted that, in FIG. 10 and FIG. 11, components common to those of the second embodiment illustrated in FIG. 7 and FIG. 8 are denoted by the same reference numerals and characters, and detailed description thereof is omitted.

In FIG. 10, the third embodiment is different in that the image processing apparatus 20-3 of the third embodiment includes a contrast comparison unit 50 instead of the matching degree comparison unit 40 included in the image processing apparatus 20-2 of the second embodiment illustrated in FIG. 7.

The contrast comparison unit 50 included in the signal processing unit 24-3 calculates the contrast of respective images which are cut out by the pair of search windows 16L and 16R which is set so as to sandwich the parallax outline 10. In the present embodiment, for the contrast of the image, the dispersion or standard deviation of a pixel value (luminance value) of the image within the search window is calculated, and the calculated dispersion or standard deviation is used as an index indicating the magnitude of the contrast of the image (Step S40 in FIG. 11).

Then, the parallax correction unit 36 determines the search window having a larger dispersion or standard deviation (contrast) of the dispersions or standard deviations which are calculated for each of the search windows 16L and 16R, as a search window including the occlusion region (Step S42 in FIG. 11), and corrects the parallax of the occlusion region in accordance with a result of the determination.

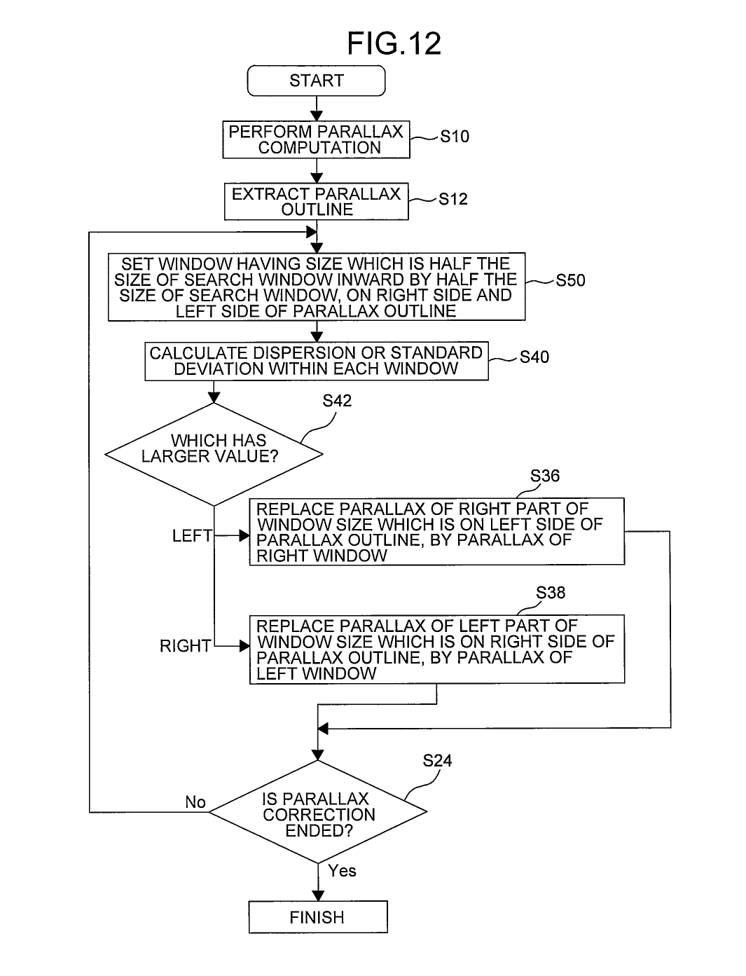

FIG. 12 is a flowchart illustrating a modified example of the third embodiment. The modified example is different from the third embodiment in that the processing of Step S50 is performed instead of the processing of Step S14 in the flowchart of FIG. 11.

In Step S50 of FIG. 12, windows each having a size which is half the size of the pair of search windows 16L and 16R which is in contact with the parallax outline 10 so as to sandwich the parallax outline 10 as illustrated in FIGS. 9A and 9B are set. In Step S40, the dispersion or standard deviation values of the set two windows having the half size are calculated.

It goes without saying that the presently disclosed subject matter is not limited to the embodiments described above, and various modifications can be made within a range not departing from the spirit of the presently disclosed subject matter.

What is claimed is:

1. An image processing apparatus, comprising:
an image acquisition device configured to acquire a first image and a second image which can be used for generating a stereo image;
a parallax calculation device configured to calculate a parallax indicating a shift amount and a shift direction of a corresponding pixel of the second image with respect to each pixel of the first image;
a parallax outline extraction device configured to extract a parallax outline in which the parallax suddenly changes, from a parallax map indicating the parallax calculated by the parallax calculation device;
a window setting device configured to set a pair of search windows and sequentially move the pair of search windows along the parallax outline extracted by the parallax outline extraction device, the pair of search windows being in contact with the parallax outline and opposed to each other so as to sandwich the parallax outline;
a window determination device configured to determine a search window including an occlusion region on the basis of the first image within the pair of search windows set by the window setting device; and
a parallax correction device configured to correct a parallax of the occlusion region within the search window determined by the window determination device, on the basis of a parallax of another search window which is not determined by the window determination device.

2. The image processing apparatus according to claim 1, wherein
the parallax calculation device detects, by block matching between the second image and an image having a predetermined block size defined with reference to a target pixel of the first image, a corresponding pixel of the second image corresponding to the target pixel of the first image, to thereby calculate the parallax between the target pixel of the first image and the corresponding pixel of the second image.

3. The image processing apparatus according to claim 2, wherein
the search window has a size which is the same as the predetermined block size defined when the parallax calculation device calculates the parallax.

4. The image processing apparatus according to claim 1, wherein:
the window determination device includes an image outline extraction device configured to cut out images within the pair of search windows from the first image and extract an image outline from each of the cut-out images; and
the window determination device determines a search window corresponding to an image having a larger image outline extracted by the image outline extraction device, as the search window including the occlusion region.

5. The image processing apparatus according to claim 4, wherein
the parallax correction device corrects the parallax between the image outline within the search window determined by the window determination device and the parallax outline, on the basis of the parallax of the another search window which is not determined by the window determination device.

6. The image processing apparatus according to claim 1, wherein:
the window determination device includes a matching degree calculation device configured to cut out images within the pair of search windows from the first image and calculate a matching degree between divided images obtained by dividing each of the cut-out images into a right part and a left part; and
the window determination device determines a search window corresponding to an image having a lower matching degree calculated by the matching degree calculation device, as the search window including the occlusion region.

7. The image processing apparatus according to claim 6, wherein
the matching degree calculation device calculates the matching degree by one of pattern matching and histogram matching of the divided images obtained by dividing into two.

8. The image processing apparatus according to claim 1, wherein:
the window determination device includes a contrast calculation device configured to cut out images within the pair of search windows from the first image and calculate a contrast of each of the cut-out images; and
the window determination device determines a search window corresponding to an image having a larger contrast calculated by the contrast calculation device, as the search window including the occlusion region.

9. The image processing apparatus according to claim 8, wherein
the contrast calculation device calculates one of a dispersion and a standard deviation of a pixel value of each of the cut-out images as an index indicating a magnitude of the contrast.

10. The image processing apparatus according to claim 5, wherein
the parallax correction device corrects the parallax which is within the search window determined by the window determination device and corresponds to a parallax which is located on a side of the parallax outline, of parallaxes divided into a right part and a left part, on the basis of the parallax of the another search window which is not determined by the window determination device.

11. The image processing apparatus according to claim 5, wherein:
the parallax correction device includes a device configured to extract the image outline from the image within the search window determined by the window determination device; and
the parallax correction device corrects the parallax between the extracted image outline and the parallax outline, on the basis of the parallax of the another search window which is not determined by the window determination device.
